(19) United States
(12) Patent Application Publication
(10) Pub. No.: US 2005/0282496 A1
(43) Pub. Date: Dec. 22, 2005

(54) Methods and devices for network access control

(75) Inventor: Martyn Carl Halsall, Albany (NZ)

Correspondence Address: MERCHANT & GOULD PC, P.O. BOX 2903, MINNEAPOLIS, MN, 55402-0903, US

(73) Assignee: Wizzwifi Limited, Albany (NZ)

(21) Appl. No.: 11/146,881

(22) Filed: Jun. 6, 2005

(30) Foreign Application Priority Data
Jun. 8, 2004 (NZ) NZ 533405

(51) Int. Cl. H04Q 7/20

(52) U.S. Cl. 455/41.2; 455/422.1

(57) ABSTRACT

A method of controlling access to a wide area network is provided. The method may be used for wireless internet access. A server for providing wide area network communication, communicates with a terminal and only allows access to the wide area network by the terminal if a predetermined program is running on the terminal. The predetermined program causes information to be displayed on the screen of the terminal during network access. Devices for implementing the method are also described and claimed.

### TECHNICAL FIELD

The present invention relates to methods and apparatus for controlling network access and in particular, but not exclusively to such when applied to a network having wireless access.

### BACKGROUND

Wireless internet has received much attention recently as a new and convenient way to provide internet access. Typically, wireless internet is provided by a wireless local area network (WLAN) connecting user to the existing fixed line infrastructure. However, methods of using this new technology in a commercial business model are still in their infancy and no-one is certain as to exactly how the cost of providing wireless internet access will be recovered.

The most commonly used protocols for wireless internet access are the IEEE 802.11 standards. Wireless networks operating using this standard are now commonly referred to as WiFi networks. WiFi networks are a subset of the broader WLAN category and operate in an unlicensed part of the radio spectrum.

An object of the present invention is to provide technology that allows wireless internet access to be controlled in a way which presents new opportunities for commercial exploitation of wireless internet access. Although the present invention may be particularly suited and adapted for use in controlled wireless internet access, it may also have application to fixed line access.

An alternative object of the present invention is to provide technology for wireless network access and a methodology for wireless network access that provides the public with a useful choice over existing technologies and methodologies.

### SUMMARY OF THE INVENTION

According to a first aspect of the present invention there is provided a network access device comprising a communication interface to a network, a computer processor, computer memory and a user interface having a display, the computer memory storing instructions readable and executable by the computer processor to cause the network access device to:
a) display on the display predetermined information communicated from the network to the network access device through the communication interface independently of actions by a user of the network access device;
b) allow user access to the network using any application running on the network access device adapted for that purpose when said information is being displayed on the display and not otherwise.

Preferably, the instructions further cause the computer processor to communicate identification information specific to at least one of the network access device and user of the network access device to at least one address in the network. The instructions may further cause the computer processor to receive from a user through the user interface and communicate configuration information to at least one address in the network, the configuration information specifying at least one characteristic that can be used to determine the predetermined information communicated from the network to the network access device and the at least one address may be the same as the address to which the identification information is sent.

Preferably, the instructions may further cause the computer processing means to require a user to use the user interface to enter configuration information before allowing access to the network by one of the network access device generally and by a particular user of that device for the first time, and communicate the configuration information to an address in the network after it has been entered.

Preferably, the instructions may further cause the computer processing means to allow the user to use the user interface to change the configuration information, wherein if the configuration information is changed, the changed configuration information is communicated to the network. The configuration information may comprise interest areas of a user of the network access device. The configuration information may identify what the user may be interested in purchasing or consuming. The configuration information may further comprise a status indicator of the user, the status indicating a type of product or service that the user may be interested in purchasing or consuming due to their status.

Preferably, the configuration information may comprise identification of what loyalty schemes the user subscribes to.

Preferably, the instructions may cause the computer processing means to
c) communicate with a network access point, receive data from the network access point and dependent on one of the data received and whether or not any data of a predetermined type was received, perform one of
i) require the information to be displayed on the display in order to access the network through that network access point and
ii) allow access to the network through that network access point irrespective of whether or not the information is displayed on the display.

Preferably, the instructions may cause the computer processing means to perform step a) and one of steps i) and ii) every time a connection between the network access device and the network is established.

Preferably, the instructions may further cause the computer processing means to communicate with a network access point, receive data from the network access point and communicate that data to a particular network address. The data received by the network access point comprises geographical location data.

Preferably, the communication interface is a wireless interface.

According to a second aspect of the invention, there is provided a computer server having a communication interface for communicating data with a computer network, the computer server operable to receive from the network identification information, configuration information that has associated with it a network address, and geographical information indicating the source of the identification information and configuration information, and send data addressed to the network address, the data defining information to be displayed on a display and selected from a plurality of different options dependent on the geographical information and configuration information, wherein the configuration information comprises at least one of:
a) the interest areas of a user;
b) what the user may be interested in purchasing or consuming; and
c) identification of what loyalty schemes the user subscribes to.

According to a third aspect of the present invention, there is provided a network access node comprising a first data communication interface to a network, a second data communication interface for communicating with at least one network access device that comprises one or more applications allowing a user to receive and send information to and from network, and computer processing means operable to cooperate with the user access device to send to the network information addressed to at least one predetermined address in the network, the information identifying at least one of the network access device and a user of the network access device and the geographical location of the apparatus.

According to a fourth aspect of the present invention, there is provided a computer network comprising the network access node defined in the preceding paragraph and at least one network access device in communication with the second data communication interface, wherein the network access device and the network access node cooperate to one of
only allow the network access device to send and receive information using the network access node that through the first data communication interface if predetermined information is sent by the network access node to the network access device and displayed on a display of the network access device, and
only allow the network access device to send and receive second predetermined information using the network access node that through the first data communication interface if predetermined information is sent by the network access node to the network access device and displayed on a display of the network access device.

Preferably, the second predetermined information comprises data defining instructions to allow the network access device to receive and display on its display the predetermined information.

According to a fifth aspect of the present invention, there is provided a method of controlling access to a wide area network at specific access points using a terminal, the method comprising:
providing at each access point a server for providing wide area network communication, the server operable to communicate to a terminal that the access point is one of said specific access points;
only allowing access to the wide area network by said terminal using one of said specific access points if a predetermined program is running on the terminal;
   wherein the predetermined program causes information to be displayed on the screen of the terminal during network access.

Preferably, the method may further comprise authenticating a user of the access program before providing network access.

Preferably, the step of only allowing access to the wide area network comprises allowing access to the wide area network using a plurality of application programs.

Preferably, the method may further comprise identifying the location of connection to the wide area network, and displaying information on the terminal that is dependent on the location information.

Preferably, the method may further comprise identifying one of the user of the terminal and the terminal itself and displaying information on the terminal dependent on the step of identifying.

Further aspects of the present invention will become apparent from the following description, given by way of example only of preferred embodiments and with reference to the accompanying drawings.

### BRIEF DESCRIPTION OF THE DRAWINGS

FIG. 1: Shows a possible network structure in which the present invention may be implemented.

FIG. 2: Shows a simplified example of a screen display according to an aspect of the present invention.

FIG. 3: Shows a flow diagram of a possible procedure for providing access to a network according to one embodiment of the present invention.

FIG. 4: Shows a schematic representation of a preferences window.

FIG. 5: Shows a representation of a location status window.

FIG. 6: Shows a functional block diagram representation of a possible network structure in which the present invention may be implemented.

### DETAILED DESCRIPTION OF THE DRAWINGS

The present invention relates to technologies and methodologies, which in the preferred embodiment as described herein, are suited and adapted for use and are used for providing controlled wireless internet access. However, the invention may also have application to fixed line access.

FIG. 1 shows a wide area network 100, in this case the Internet, in which the present invention may be implemented. In communication with and as part of the wide area network 100, are two servers 201, 301, which respectively form part of two wireless local area networks (WLANs) 200 and 300. The servers 201, 301 may form part of the communication gateway between the WLANs 200, 300 and the wide area network 100. A corporate network 400 is also in communication with the wide area network 100 through a firewall 401 and in the embodiment shown includes a first server 402, second server 403 and third server 404. Many personal computers 500 connect directly to the wide area network 100, typically through an internet service provider.

The WLANs 200 and 300 may be implemented in accordance with IEEE standard 802.11b or 802.11g, commonly referred to as Wi-Fi. WLAN 200 includes two hotspots 202, 203 and two exemplary personal computers 204, 205 are shown in communication with the hotspots. WLAN 300 also includes two hotspots 302, 303 and one exemplary personal computer 304 and one exemplary PDA 305 is shown in communication with the hotspot 302.

Those skilled in the relevant arts will appreciate after reading the following description that the network 100 is only one possible example of a network configuration that may be used with the present invention.

The present invention may be particularly useful in the provision of internet access to members of the public by businesses, particularly businesses whose core business activities do not include providing internet access. The businesses may provide free access to the internet in return for the user displaying on their screen certain information while they are accessing the internet, but a paid service is also possible. Although the business model and present invention is anticipated to be most applicable where the internet access is via a WLAN, particularly WiFi in the current economic environment, so that the businesses that subscribes to the business model sets up a hotspot at its trading location, this is not essential.

Each of the personal computers 204, 205, 304 and the PDA 305 has a program installed, which is referred to herein as “the access program”. The following description refers to the personal computer 304, but is applicable to other personal computers and wireless devices. Some modifications may be made to the access program dependent on the particular device used. For example, the typically more limited display space and processing ability of a PDA may require modifications to the ticker style display and access program. As described in more detail herein below, the access program must be running before the user of the personal computer 304 can use either of the servers 201, 301 to access the internet, preferably subject to some exceptions for downloading the access program and registering a device or user an optionally also for accessing webmail only.

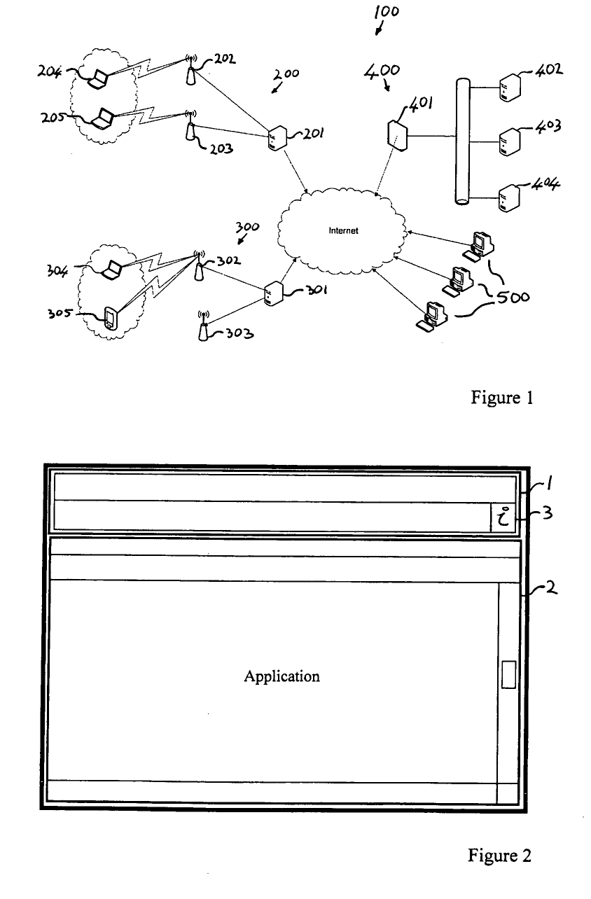

Referring to FIG. 2, a simplified representation of a screen display for the PDA 304 is shown. The access program causes the personal computer 304 to display on its screen a ticker-style display 1. In the embodiment shown, the ticker-style display 1 has two rows, although one or more than two rows may be displayed. The ticker-style display 1 displays information to the user of the personal computer 304 whenever the user is accessing the internet using the personal computer 304 via a business subscribing to the aforementioned business model. Preferably the ticker-style display 1 can not be minimised or closed without terminating the connection to the Internet, and is always displayed on top. The latter requirement may be achieved by resizing the desktop so that all other applications are displayed outside the area of the ticker style display 1. In FIG. 2, an application display 2 is shown covering the entire desktop below the ticker-style display 1. The ticker-style display 1 may be positioned at other locations on the screen of the PDA 304.

In use, the ticker-style display 1 may display information that could benefit the business (hereinafter “the subscribing business”) that is providing internet access according to the aforementioned business model. For example an advertisement of the products or services available for purchase at the subscribing business may be displayed in the ticker-style display 1. If another business which is located near the subscribing business that is providing internet access wishes to have information displayed on the ticker-style display 1, there is an opportunity for the subscribing business to charge a fee for this. Therefore, the cost of providing internet access may be offset against both potential increased purchases resulting from the on-screen advertising and fees provided by other businesses. Where the density of users is insufficient to support this business model, a user subscriber fee may optionally also be charged. This could be collected by an administrative organisation, for example the organisation that manages the corporate network 400. This organisation may also collect a fee from each subscribing business, for example a monthly fee.

An advantage of using a ticker-style display is that there is constant movement of the information across the screen of the personal computer 304, which may draw the attention of the user better than if static banners were used and the information displayed may change over time. Also, by selecting an item in the ticker-style display the user may be directed to a particular web-site or a pop-up window may be displayed, giving further information about the item in the ticker style display. However, other types of displays may be used with the present invention.

As described in more detail herein below, the access program on first installation is configured by the user. The configuration information may be specific to the personal computer 304, or specific to each user of the personal computer 304, in which case the users need to identify themselves using a user name. The configuration information may include the consumption preferences of the user. For example and without limitation, the configuration information may specify whether the user drinks coffee, what sports they play and possibly their age and sex. The information displayed by the ticker-style display 1 may then reflect the user preferences, helping to ensure that information relevant to the user is displayed.

In addition, the configuration information may specify the loyalty programmes or any other trading programmes that the user subscribes to or is a member of. The information displayed can then be selected dependent on the loyalty programmes.

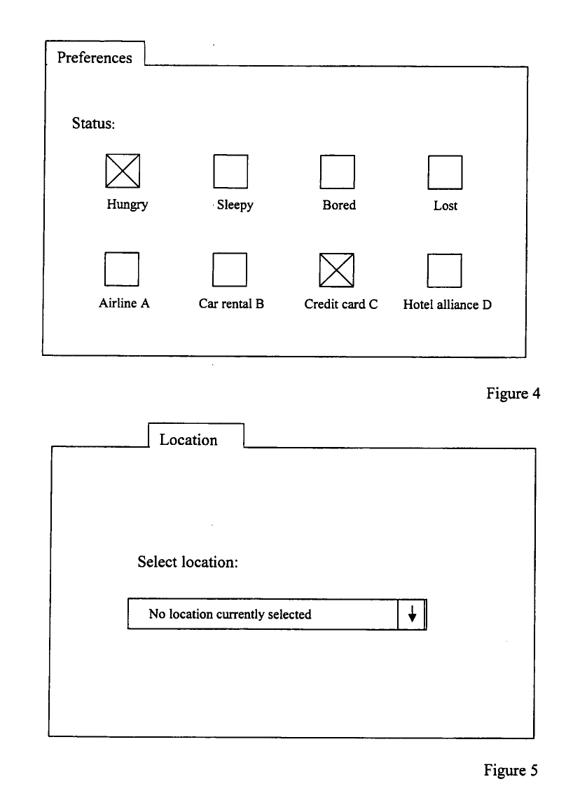

The configuration information may be able to be updated or specified by the user after the first installation of the access program. The ticker-style display 1 may include an icon 3, that when selected by the user displays a configuration window. Two example configuration windows C1 and C2 are shown in FIGS. 4 and 5 respectively, with configuration window C1 allowing a user to select preferences indicating their current status and the configuration window C2 allowing a user to select their current location or another location of interest to them using a drop down menu. As shown, the configuration window may be in the form of a questionnaire with multiple choice answers (in the simplest form the answers may be yes or no), in which case the configuration information can be standardised. In addition, the user may be able to indicate status information. In the example shown in FIG. 4, the user has selected a box that indicates that they are currently hungry, in which case the ticker-style display may provide information on local restaurants. In the example shown in FIG. 5, the user has selected a credit card, in which case restaurants that provide reward points for using that type of credit may be, for example, displayed highlighted.

The user may use a point and click device to select an item in the ticker-style display 1. Upon selection, further information may be displayed, most suitably by a URL or in a pop-up window (not shown). Taking the example of a local restaurant, the further information may include exactly where the restaurant is located and may also include a menu.

Another example of configuration information that may be specified by the user after the first installation of the access program is a destination. For example, the user may specify a shopping mall. The ticker-style display 1 may then display information relating to businesses at that shopping mall. The ticker-style display 1 may also display what loyalty programmes businesses at that mall offer so that the user can know in advance what loyalty cards or the like they should take with them. Where the configuration information specifies the loyalty programmes that the user belongs to, the ticker-style display 1 may display information on only the loyalty programmes offered by businesses at the shopping mall that the user belongs to. If the ticker-style display 1 includes two or more rows, the loyalty information may exclusively occupy one row.

The configuration information for a user may be stored at the corporate network 400 and accessible through the Internet. This allows a user to manage their configuration information through any connection of to the internet. To avoid unauthorised access and modification, suitable security protection, including for example a user name and password, is used. The preferences of the user, particularly those that change often over time may advantageously be indicated using either the access program or through the Internet generally.

It will be apparent from the foregoing description of the configuration information that it is not essential that the user access the internet through a subscribing business. However, for the information to be specific to their location, they will need to specify their current or intended physical location as a destination.

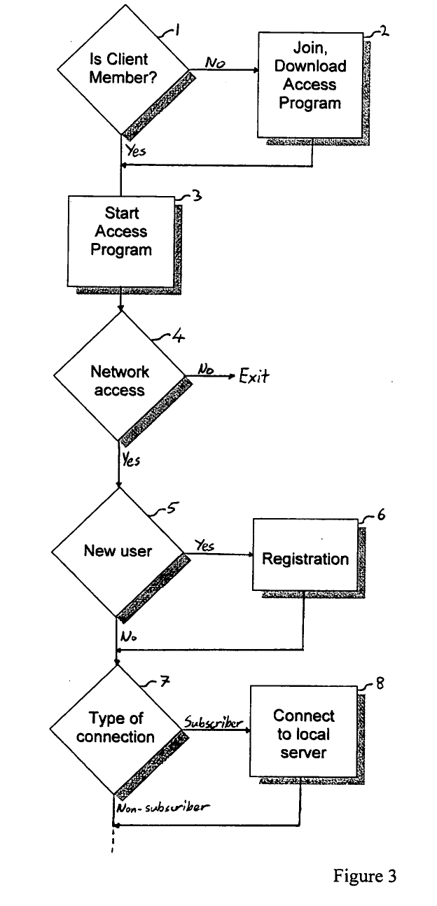

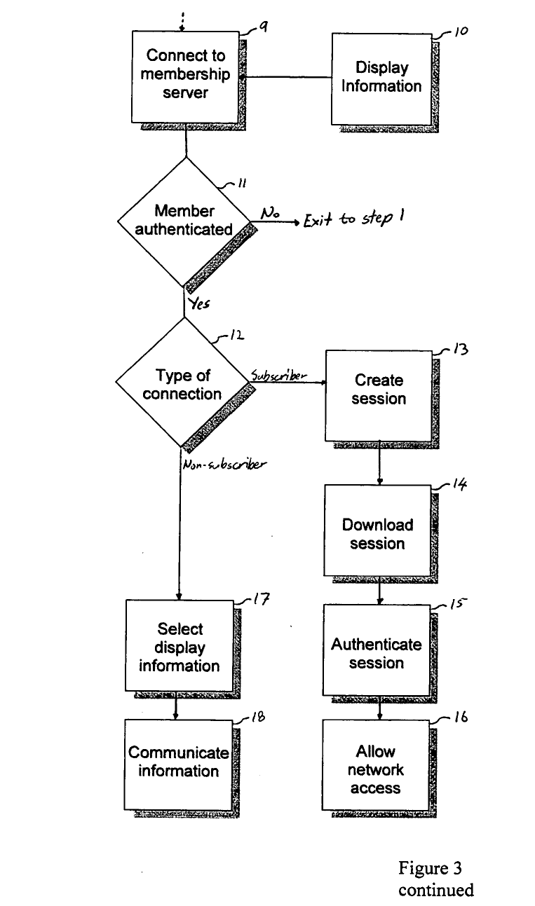

FIG. 3 shows a flow diagram of the steps performed for a user to access the internet. For clarity, reference is made to the personal computer 304 shown in FIG. 1, although those skilled in the relevant arts will appreciate that the process has a more general application. Before a user can access the internet using the personal computer 304 and a hotspot of a subscribing business, the personal computer 304 must have an access program installed. Therefore, the first step (step 1) is for the user to establish whether the access program has been installed on the personal computer 304. If not, the program is installed, optionally by downloading it from an internet web-site (step 2) to which the user may be directed and restricted access to the internet may be available through the hotspot of the subscribing business to allow this to occur. If the access program is installed, it is started (step 3).

Optionally, as described further herein below some services may be available using a hotspot of a subscribing business by unregistered users, including webmail. In this case, limited internet access is provided without the access program being installed or started, to allow this.

Steps 1-3 may also be performed in part automatically. In step 1, when the personal computer 304 that does not have an access program installed on it or running attempts to connect to the internet using a hotspot of a subscribing business, either the server 301 interrogates the personal computer 304 to establish whether the personal computer 304 has the access program installed on it or the server 301 detects the absence of information transmitted from the personal computer 304 that if present indicates that the access program has been installed. If the access program is not installed or is not running, the server may request that the personal computer 304 display in its screen an error message. The error message may request that the user either start the access program if they already have it installed or download the access program. The server 301 may allow access to the internet by the personal computer 304 solely for the purpose of downloading the access program (step 2). Alternatively, in a less preferred embodiment, the access program may be stored locally at the server 301 so that internet access is not required. The access program is then installed and started at the personal computer 304, either by the user or automatically (step 3).

The access program then determines if network access if available and if the user is requesting internet access (step 4). If not, the process exits. If internet access is available and requested, the access program establishes if the user has been previously registered or not (step 5). If the user has not been registered, they are requested to enter user identification and configuration information (described herein above) (step 6). Steps 5 and 6 may alternatively be performed in advance during step 2 instead of at this stage. This information is communicated to (or retrieved from memory once communication is established by) a membership server 403 located in the corporate network 400. The membership server 403 stores a register of users in a database.

In step 7, the access program establishes whether the requested connection to the internet requires use of a subscribing business hotspot. This is indicated by the presence of the server 302 at a predetermined private address. In the absence of such a server, the access program knows that the personal computer 304 is connecting to the internet using a non-subscribing business connection and the process proceeds to step 9. If the connection is through a subscribing business, a connection between the personal computer 304 and the server 302 is commenced (step 8). Preferably this process may occur automatically, although if an automatic connection fails the user may manually specify the location where they are attempting to connect in a configuration menu. As part of this, some information from the server 301 may be downloaded to the personal computer 304. This information may include an indication of the geographical location of the server 301 or more preferably, the geographical location of the transceiver 302 if it is different from the location of the server 301. Alternatively, information indicating geographical location may be added by the server 301 to communications from the personal computer 304 to the corporate network 400.

In step 9, the access program automatically connects to a membership server 403 located in the corporate network 400. The address of the membership server 403 is stored in memory at the personal computer 304 to enable this. The address could be obtained from the server 301 as part of step 8 or included with the access program when it is first downloaded and installed.

Generic information for display on the screen of the personal computer 304 may optionally then be provided to the personal computer 304 by the membership server 403 (step 10). If the connection is through a subscribing business, the location of the user is known and therefore the generic information can be location specific. Step 10 allows a general broadcast function for any one who has the access program running on their terminal, regardless of whether or not the user requires internet access for other purposes.

The identification information of the personal computer 304 and/or the user of the personal computer 304 are then sent to the membership server 403, which compares this with its membership database, allowing recall from the membership database of the configuration information for that device/user (step 11).

If the member is not authenticated (not registered at the membership server 403), the process exits. If the user is attempting to access the internet using the server 301, they are denied access. If the user is attempting to access the internet using a non-subscribing business server (including an Internet Service Provider), they are allowed access using their normal means and the broadcast information, if provided, is displayed on their screen for as long as the user keeps the display window open. Closing the display window for the access program does not affect network access in this situation.

If the member is authenticated, the membership server 403 determines whether or not the user is connecting through a subscribing business (step 12). It can determine this by whether the personal computer 304 indicates that it successfully connected with the server 301. The personal computer 304 will also communicate to the membership server 403 geographical location information obtained from the server 301. If the connection is through a subscribing business, the membership server 403 and authentication server 404 creates session details (step 13). The session details are sent to the personal computer 304 (step 14). The session details may be encrypted before being sent to the personal computer 304.

The open source NoCat authentication code may be used for authentication. Those skilled in the relevant arts will appreciate that alternative exist.

The access program already knows from step 7 that a connection is to be made using a subscribing business and therefore, before internet access is provided, it requests authentication from the authentication server 404 (step 15). Once this has been received, the access program allows full internet access to the personal computer 304 (step 16), and the access program causes the display to remain on the screen. The corporate network 400 communicates information to the personal computer 304 for display on its screen and the personal computer 304 communicates back to the corporate network 400 any change in the configuration information entered by the user or any request for specific information from the user. Access to the internet is terminated by the access program if the user closes the ticker-style display. Access may also be terminated if the user disallows access by the access program to the internet.

If in step 12, the membership server 403 determines that a connection is to be made though a non-subscribing business, information is compiled by the corporate network for display that is specific to the user, but not specific to any location (step 17). This information is then sent to the personal computer 304 (step 18). The connection to the internet is not affected by the closing of the ticker-style display.

The corporate network 400 may provide additional services to users. For example, a web-mail server 402 may be provided. Use of the web-mail server may require display of the ticker-style display 1, regardless of whether or not the user is connected to the internet through a subscribing business. Alternatively, web-mail may be able to be used without display of the ticker-style display 1 and may be used to provide information about the access program and the services available by registering.

Those skilled in the relevant arts will appreciate that alternative embodiments could be implemented in which specific steps of the process are performed by alternative devices. For example, some of the functions of the personal computer 304 invoked by the access program could be performed by the server 301, which may reduce the options for someone circumventing the requirement to run the genuine access program on the personal computer 304. Also, some functions performed by or within the corporate network 400 may be distributed rather than centralised.

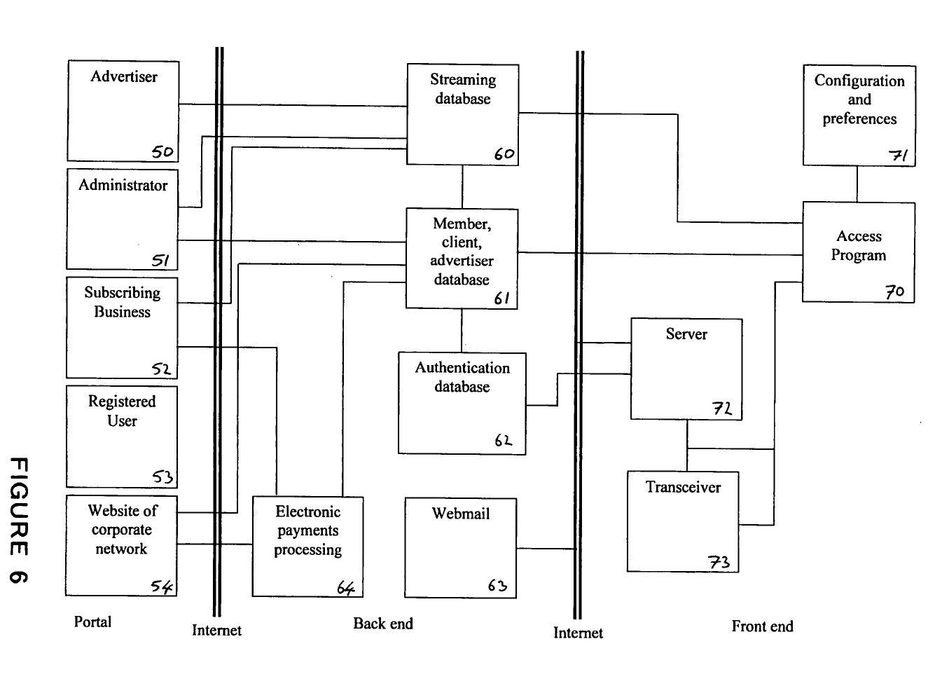

FIG. 6 shows a functional block diagram of an example system according to the present invention. The functions are shown separated into a back end, a portal to the back end and a front end and the lines between the blocks represent information flow rather than physical connections. The front end includes the access program 70, which includes configuration and preferences setting functionality represented by box 71, a sever 72, which may be, for example the server 301 described herein above in relation to FIG. 1, and a transceiver 73, which may be, for example the transceiver 302 described herein above in relation to FIG. 1. The back end includes:
a streaming database 60, which contains the advertisements and other information displayed by the access program 70;
a member, client, advertiser database 61, which contains details of the various entities that use or have access to the back end;
an authentication database 62, which contains information required to authenticate users;
webmail sever 63 (if provided);
electronics payment processing 64 (if provided).

The portal provides access to:
advertisers 50 to allow them to maintain advertisements stored in the streaming database 60 that are to be displayed by the access program 70;
an administrator 51 to allow maintenance of a website and the details of subscribing businesses, registered users and advertisers;
subscribing businesses 52, to allow selection of advertisers and/or advertisements from the streaming database 60 that are to be displayed by the access program 70 when a registered user 53 is using their access facilities, including the management and/or creation of their own promotions;
registered users 53, to allow configuration information to be entered or changed and optionally also to allow preferences to be indicated. If electronic payments processing is supported (see herein below), then the user may access their transaction history and other details.

A website 54, which may be managed by a web server of the corporate network or otherwise is also shown in FIG. 6. The website may allow users to register, download the access program 70 and update configuration information.

In use, the access program 70 receives advertisements and other information for display in a ticker-style display as described herein above from the streaming database 60. The information sent is dependent on the configuration information, including any preferences for the user as stored or communicated to the member, client, advertiser database 61. The information sent may also be dependent on the geographical location of the server 72 or transceiver 73 that the device in which the access program 70 is resident is using to access the internet, which in the embodiment shown is communicated to the member, client, advertiser database 61 by the access program 70, after this information has been received by the access program 70 from the server 72.

Where in the foregoing description reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

1. A network access device comprising a communication interface to a network, a computer processor, computer memory and a user interface having a display, the computer memory storing instructions readable and executable by the computer processor to cause the network access device to:
a) display on the display predetermined information communicated from the network to the network access device through the communication interface independently of actions by a user of the network access device;
b) allow user access to the network using any application running on the network access device adapted for that purpose when said information is being displayed on the display and not otherwise.

2. The network access device of claim 1, wherein the instructions further cause the computer processor to communicate identification information specific to at least one of the network access device and user of the network access device to at least one address in the network.

3. The network access device of claim 2, wherein the instructions further cause the computer processor to receive from a user through the user interface and communicate configuration information to at least one address in the network, the configuration information specifying at least one characteristic that can be used to determine the predetermined information communicated from the network to the network access device.

4. The network access device of claim 3, wherein the at least one address is the same as the address to which the identification information is sent.

5. The network access device of claim 3, wherein the instructions further cause the computer processing means to require a user to use the user interface to enter configuration information before allowing access to the network by one of the network access device generally and by a particular user of that device for the first time, and communicate the configuration information to an address in the network after it has been entered.

6. The network access device of claim 3, wherein the instructions further cause the computer processing means to allow the user to use the user interface to change the configuration information, wherein if the configuration information is changed, the changed configuration information is communicated to the network.

7. The network access device of claim 6, wherein the configuration information comprises interest areas of a user of the network access device.

8. The network access device of claim 6, wherein the configuration information identifies what the user may be interested in purchasing or consuming.

9. The network access device of claim 8, wherein the configuration information comprises a status indicator of the user, the status indicating a type of product or service that the user may be interested in purchasing or consuming due to their status.

10. The network access device of claim 6, wherein the configuration information comprises identification of what loyalty schemes the user subscribes to.

11. The network access device of claim 1, wherein the instructions cause the computer processing means to
c) communicate with a network access point, receive data from the network access point and dependent on one of the data received and whether or not any data of a predetermined type was received, perform one of
i) require the information to be displayed on the display in order to access the network through that network access point and
ii) allow access to the network through that network access point irrespective of whether or not the information is displayed on the display.

12. The network access device of claim 11, wherein the instructions cause the computer processing means to perform step a) and one of steps i) and ii) every time a connection between the network access device and the network is established.

13. The network access device of claim 11, wherein the instructions further cause the computer processing means to communicate with a network access point, receive data from the network access point and communicate that data to a particular network address.

14. The network access device of claim 11, wherein the data received by the network access point comprises geographical location data.

15. The network access device of claim 1, wherein the communication interface is a wireless interface.

16. A computer server having a communication interface for communicating data with a computer network, the computer server operable to receive from the network identification information, configuration information that has associated with it a network address, and geographical information indicating the source of the identification information and configuration information, and send data addressed to the network address, the data defining information to be displayed on a display and selected from a plurality of different options dependent on the geographical information and configuration information, wherein the configuration information comprises at least one of:
a) the interest areas of a user;
b) what the user may be interested in purchasing or consuming; and
c) identification of what loyalty schemes the user subscribes to.

17. A network access node comprising a first data communication interface to a network, a second data communication interface for communicating with at least one network access device that comprises one or more applications allowing a user to receive and send information to and from network, and computer processing means operable to cooperate with the user access device to send to the network information addressed to at least one predetermined address in the network, the information identifying at least one of the network access device and a user of the network access device and the geographical location of the apparatus.

18. A computer network comprising the network access node of claim 17 and at least one network access device in communication with the second data communication interface, wherein the network access device and the network access node cooperate to one of
only allow the network access device to send and receive information using the network access node that through the first data communication interface if predetermined information is sent by the network access node to the network access device and displayed on a display of the network access device, and
only allow the network access device to send and receive second predetermined information using the network access node that through the first data communication interface if predetermined information is sent by the network access node to the network access device and displayed on a display of the network access device.

19. The computer network of claim 18, wherein the second predetermined information comprises data defining instructions to allow the network access device to receive and display on its display the predetermined information.

20. A method of controlling access to a wide area network at specific access points using a terminal, the method comprising:
providing at each access point a server for providing wide area network communication, the server operable to communicate to a terminal that the access point is one of said specific access points;
only allowing access to the wide area network by said terminal using one of said specific access points if a predetermined program is running on the terminal;
wherein the predetermined program causes information to be displayed on the screen of the terminal during network access.

21. The method of claim 20, further comprising authenticating a user of the access program before providing network access.

22. The method of claim 20, wherein the step of only allowing access to the wide area network comprises allowing access to the wide area network using a plurality of application programs.

23. The method of claim 20, further comprising identifying the location of connection to the wide area network, and displaying information on the terminal that is dependent on the location information.

24. The method of claim 20, further comprising identifying one of the user of the terminal and the terminal itself and displaying information on the terminal dependent on the step of identifying.
